(19) United States
(12) Patent Application Publication
(10) Pub. No.: US 2022/0142133 A1
(43) Pub. Date: May 12, 2022

(54) MAGNETIC LEVITATION SPOOL ASSEMBLY FOR ICE FISHING TIP-UPS

(71) Applicants: Nick William Wichert, Whitefish Bay, WI (US); Jason Mikula, Palmyra, WI (US)

(72) Inventors: Nick William Wichert, Whitefish Bay, WI (US); Jason Mikula, Palmyra, WI (US)

(21) Appl. No.: 17/454,174

(22) Filed: Nov. 9, 2021

Related U.S. Application Data
(60) Provisional application No. 63/111,981, filed on Nov. 10, 2020.

(51) Int. Cl. A01K 97/01; A01K 89/015

(52) U.S. Cl. CPC A01K 97/01; A01K 89/01931

(57) ABSTRACT

A magnetic levitation spool assembly for a tip-up device, the assembly providing the following: a shaft extending between a spool end and a trip mechanism end; a board engager disposed along the shaft between the spool end and the trip mechanism end; a first pair of magnetized objects between the spool end and the board engager; and a second pair of magnetized objects between the trip mechanism end and the board engager, wherein the first and second pair of magnetized objects magnetically repel each other to produce a gap between each pair of magnetized objects and the board engager.

### CROSS-REFERENCE TO RELATED APPLICATION

This application claims the benefit of priority of U.S. provisional application number 63/111,981, filed 10NOV. 2020, the contents of which are herein incorporated by reference.

### BACKGROUND OF THE INVENTION

The present invention relates to ice fishing and more particularly, to a magnetic levitation spool assembly for ice fishing tip-ups.

A tip-up is a device used while ice fishing to suspend live or frozen bait at a set depth through a hole drilled in the ice. The tip-up detects when a fish strikes without the angler having to be in physical contact with the fishing gear. And when a fish does take the bait, a flag “tips up” (or the flag can “tip down”) to signal the angler that a fish has taken the bait. As a result, anglers can see the flag from a distance and can thus manage multiple holes at once, covering a larger area than with just an ice fishing rod.

Traditional tip-ups, however, succumb to the force of gravity during use, whereby separate components of the tip-up rub, resulting in friction, which in turn causes the separate components to not perform as desired. During winter conditions, this problem is amplified due to freezing rain, snow, and other harsh winter conditions that causes the mechanical parts to freeze together so that they do not spin or otherwise operate as designed. This results in the angler losing their catch more easily or seeing an increase in false flags (i.e., the fish takes the bait but, due to the resistance of the spinning components, drops it before the hook can be set). p Generally speaking, in freezing and wet conditions metal's performance substantially suffers, and specifically for tip-ups, the tip-up's metal components problematically freeze to other metal parts, locking up the tip-up's mechanical system. Metal on metal rubbing also increases friction points, inhibiting the effectiveness of the tip-up. The current solution is to use excess and potential environmentally harmful grease to reduce friction and/or eliminate separate components freezing together. This excess grease, however, may threaten the very specifies of fish the angler is aiming to catch, as well as create a mess for the angler.

Accordingly, there is a need for a magnetic levitation (maglev) spool assembly for ice fishing tip-ups. The maglev spool assembly may use two sets of opposing magnetized objects to suspend the spool assembly or a central portion thereof to eliminate the force of gravity that causes rubbing and friction between separate components along the spool assembly. As a result, the spool can spin more freely so that as the fish pulls the bait the hook is able to be set more efficiently as there is less resistance.

The present invention uses sets of magnets in opposing directions to create a suspended lift of the spool. The magnetic lift is greater than the weight of the parts and, as a result, the parts are suspended above each other reducing the friction caused by rubbing. The use of magnetic levitation spools of the present invention sees the same performance gains of that associated with high-speed magnetic levitation trains. By eliminating most of the friction caused by gravitational forces of metal-on-metal rubbing, the tip-up's overall performance improves.

### SUMMARY OF THE INVENTION

In one aspect of the present invention, a magnetic levitation spool assembly for a tip-up device, the assembly providing the following: a shaft extending between a spool end and a trip mechanism end; a board engager disposed along the shaft between the spool end and the trip mechanism end; a first pair of magnetized objects between the spool end and the board engager; and a second pair of magnetized objects between the trip mechanism end and the board engager, wherein the first and second pair of magnetized objects magnetically repel each other to produce a gap between each pair of magnetized objects and the board engager.

In another embodiment of the present invention, the assembly includes the following: a spool connected to the spool end; a trip mechanism connected to the trip mechanism end; a magnetizable tube receiving the shaft, wherein the magnetizable tube is disposed between the spool end and the trip mechanism end, and wherein the board engager is connected to magnetizable tube, wherein the gap between the magnetizable tube and each set of one or more magnetized objects is magnetically urged by each set of one or more magnetized objects, wherein each set of one or more magnetized objects comprising a pair of magnetized objects; and a magnet cap between each pair of magnetized objects, wherein each magnetized object is slidably connected to the shaft.

In another embodiment of the present invention, a method of decreasing friction between a plurality of magnetizable components of a tip-up device, wherein the plurality of magnetizable components is connected along a shaft of a spool assembly of the tip-up device, the method includes the following: disposing at least two magnetized objects along the shaft, wherein each two adjacent magnetized objects of the at least two magnetized objects is separated by a magnetizable component of the plurality of magnetizable components, wherein the two adjacent magnetized objects magnetically repel said magnetizable component to produce a gap between said magnetizable component and each of the two adjacent magnetized objects.

These and other features, aspects and advantages of the present invention will become better understood with reference to the following drawings, description and claims.

### BRIEF DESCRIPTION OF THE DRAWINGS

FIG. 1 is a perspective view of an exemplary embodiment of the present invention, shown in a used condition with the flap in a tip-up position, with the maglev spool assembly in a vertical orientation.

FIG. 2 is a perspective view of an exemplary embodiment of the maglev spool assembly 80 of the present invention.

FIG. 3 is a detailed perspective view of an exemplary embodiment of a bottom magnet configuration of a set or pair of magnetized objects of the present invention.

FIG. 4 is a detailed perspective view of an exemplary embodiment of a top magnet configuration of a set or pair of magnetized objects of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

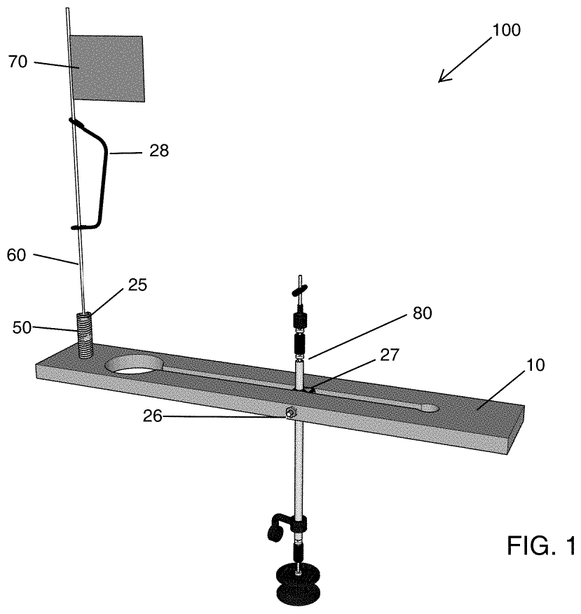

Referring to FIGS. 1 through 4, the present invention may include a maglev tip-up assembly 100 that embodies all categories of tip-ups, including but not limited to a cross-stick design, a flat-board design, a thermal tip-ups, and wind tip-ups. Thus, it is understood that even though the maglev tip-up assembly 100 shown in the attached Figures is representative of the flat-board design many different types of tip-up devices are contemplated. Accordingly, and by way of example only, the flat-board design tip-up shown in the Figures has the following tip-up components: a board 10 dimensioned and adapted to rest on the ice; a shaft 20 that runs generally perpendicular to the board 10 with a spool 30 of line on one end and a trip bar 40 on the other. A spring 50 (or any elastic object that stores mechanical energy) may be mounted to one end of the board 10, and a flagpole 60 (typically metal) is attached to the spring 50. The flag 70 is set by removably engaging the flagpole 60 and the trip bar 40 (typically by placing the flagpole 60 under the trip bar 40). When a fish bites, pulling the line spins the spool 50, therefore the shaft 20, and therefore the trip bar 40. With nothing to hold the flagpole 60 down, it springs up and alerts the angler to a strike. The maglev tip-up assembly 100 may also include a flag end cap 25 (that is reset into the spring 50) and a flag pin latch 28, as well as bolt and nut fasteners 26 and 27.

The shaft 20, the spool 30 and the trip bar 40 of the maglev tip-up assembly 100 may be embodied on a maglev spool assembly 80 having a board engager 85 disposed along the shaft 20 between the spool 30 and the trip bar 40. The board engager 85 may be dimensioned and adapted to engage the board 10 along a board recess 15 so that in a horizontal orientation (not shown) the maglev spool assembly 80 may be received therein. Accordingly, the board engager 85 allows the maglev spool assembly 80 to move between a vertical orientation and a horizontal orientation. The board engager 85 may be embodied in or connected to a central tube 88. The central tube 88 may be stainless-steel or any other magnetizable material and have an inner opening through which the shaft 20 may slide therethrough.

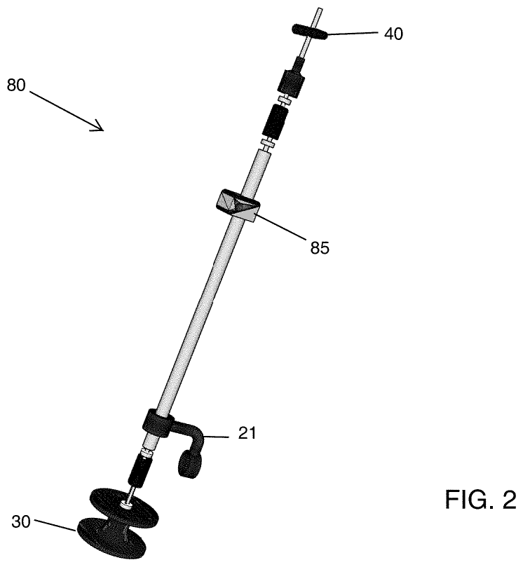

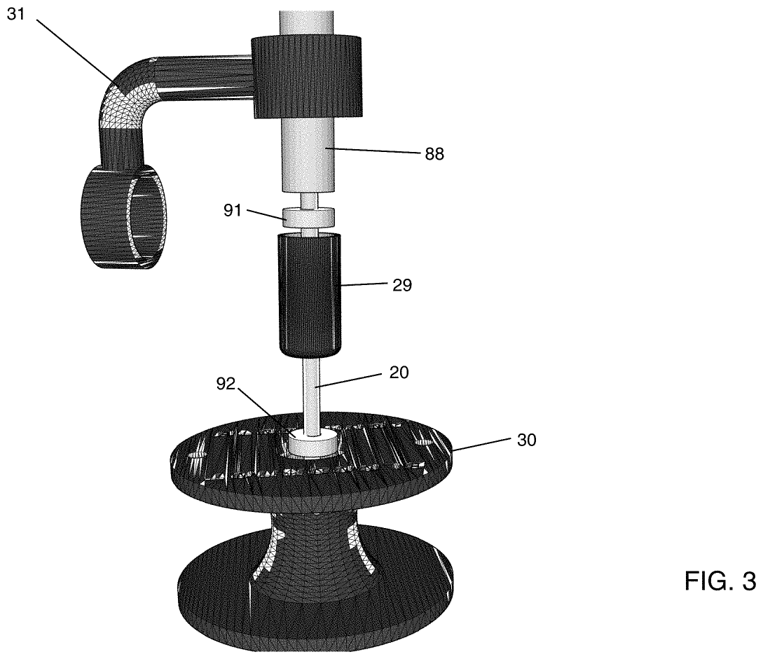

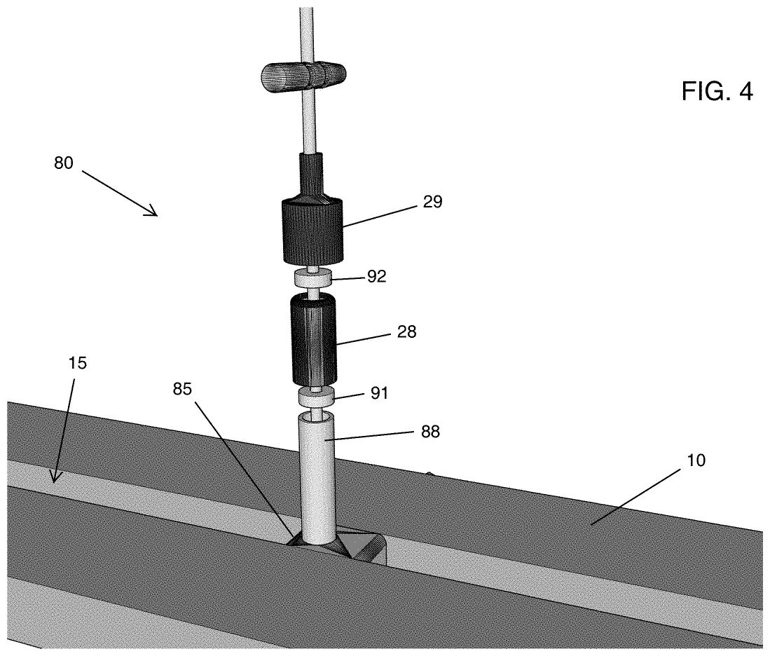

The shaft 20 also provides at least a first and/or second magnetized objects 91 and 92 between the spool 30 and the board engager 85 and at least a first and/or second magnetized objects 91 and 92 between the tip bar 40 and the board engager 85, respectively, as illustrated in FIGS. 3 and 4. The first and second magnetized objects 91 and 92 have similar polarities facing each other, and thus repel each other. The strengths of the magnetic fields of the first and second magnetized objects 91 and 92 are sufficient so that the central tube 88 is suspended between adjacent first magnetized objects 91 with no support other than magnetic fields, as illustrated in FIG. 2. This magnetic force is used to counteract the effects of the gravitational force and any other forces, resulting in magnetic levitation (maglev) lifting force.

In certain embodiments, the magnetized objects may be ⅜″×⅛″×⅛″in size. Though varying sizes of magnetized objects 91 and 92 could be used to create greater opposing magnetic forces. The total number of magnetized objects could also be reduced by modifying other manufactured parts of the maglev spool assembly 80. Magnetically conducive metals could replace two of the four magnets. In short, different size and strength magnets could be used to achieve the same magnetic levitation affect. Likewise, magnets are affixed the spool or spool assembly could be shuffled to achieve the same mechanical affect.

Furthermore, in certain embodiments, a tube cap 28 and a magnet cap 29, see FIG. 4, adapted so that the magnetized objects 91 and 92 stay in place, ensuring the spool assembly is levitated rather than pushed in one direction or the other, enabling the debilitating friction mentioned above. Referring to FIG. 4, second magnetized object 92 is fixed to the shaft 20 and/or where the shaft 20 and the spool 30 interface. First magnetized object 91 and second magnetized object 92 may define a “pair” or “set” or “configuration” of magnetized objects or magnets. The second magnetized object 92 repels the first magnetized object 91 through their polar orientation. First magnetized object 91 of FIG. 3 (illustrating the ‘bottom pair’ or ‘bottom set’ or ‘bottom configuration’ of magnetized objects) repels the first magnetized object 91 (of the ‘top pair’ or ‘top set’ or ‘top configuration’ of magnetized objects) illustrated in FIG. 4. As a result, the magnetizable tube 88 is disposed with a gap between each first magnetized object 91 and thus gaps are provided between the magnetizable tube 88 and the trip mechanism 40 and the spool 30, respectively.

In some embodiments the board 10 may be wood, though is not limited to such material. In some embodiments the shaft 20 may be a stainless-steel or any other magnetizable material spool rod that is 13.75 inches in length, though the shaft 20 is not limited to such material nor dimensionality. In some embodiments the spool 30 may be nylon plastic, though is not limited to such material. In some embodiments the trip bar 40 may be a 303 stainless-steel or any other magnetizable material flag trigger pin though is not limited to such material. In some embodiments the flagpole 60 may be a stainless-steel material flag rod 16 inches in length, though is not limited to such material nor dimensionality. In some embodiments the flag 70 may be cloth, though is not limited to such material.

A method of using the present invention may include the following. The maglev spool assembly 80 disclosed above may be provided. In certain embodiments, a user does not have to set or manipulate any of the magnetized objects 91 and 92 provided as the unit comes completely assembled so that the user may to use the tip-up device as they would regularly. To use the tip-up assembly 100 one must release the flag 70 that fits into a hole in the spool 30. Then in some embodiments the user unlocks the maglev spool assembly 80. Once unlocked the angler would rotate the maglev spool assembly 80 until it is perpendicular with the base/board 10. Once fishing line (not shown) is spooled and the line is hooked and baited, the angler would set their appropriate depth and lay the base/board 10 over the hole they drilled in the ice. To set the tip-up, the angler pulls the flag down, and sets the flag set bar on the flag pin. When a fish takes the bait, the line will rotate the maglev spool assembly 80 shaft 20 causing it to spin, releasing the flag 70, indicating that a fish has taken the bait. To reel in the catch, the angler can choose to grab the spool and spin it by hand, or they can pull the line in by hand then spool the rest of the line after they realize their catch or miss.

A wireless (such as Bluetooth™) indicator connected to an angler's smartphone that alerts when a fish has taken the bait would add additional utility. Additionally, an attached electrically heated hole warmer to the wooden base could make the tip-up more effective. In some cases, during the night when visibility of the device is limited, lights will be added to the device to signal that a flag has been triggered.

In certain embodiments, an adjustable shaft collar line guide 21 may be provided. The adjustable shaft collar line guide 21 enables the angler to set a specific tension for varying sizes of live bait. An appropriate selectively set tension reduces the likelihood that the bait fish will unspool the line by swimming around—a common problem with tip-up devices. By tightening the tension, the present invention reduces the ability for the bait fish to unspool the line and ensuring the desired depth the angler set is always maintained.

The words “about,” “approximately,” or the like, when accompanying a numerical value, are to be construed as indicating a deviation as would be appreciated by one of ordinary skill in the art to operate satisfactorily for an intended purpose. As used in this application, the term “about” or “approximately” refers to a range of values within plus or minus 10% of the specified number, and the term “substantially” refers to up to 90% or more of an entirety. Specific recitations of ranges of values herein are not intended to be limiting, referring instead individually to any and all values falling within the range, unless otherwise indicated, and each separate value within such a range is incorporated into the specification as if it were individually recited herein. Likewise, use of any and all examples, or exemplary language (“e.g.,” “such as,” or the like) provided herein, is intended merely to better illuminate the embodiments and does not pose a limitation on the scope of the embodiments or the claims. No language in the specification should be construed as indicating any unclaimed element as essential to the practice of the disclosed embodiments.

In the following description, it is understood that terms such as “first,” “second,” “top,” “bottom,” “up,” “down,” and the like, are words of convenience and are not to be construed as limiting terms unless specifically stated to the contrary. Specifically, the directional terms bottom/downward and top/upward may be defined in reference to the Figures; specifically, FIG. 1 shows the flag 70 and flagpole 60 in an ‘up’ position, and thus the board 10 is ‘downward’ relative to the flag 70. Accordingly, top/upward is directed to the upper margin of FIG. 1, while bottom/downward is directed to the lower margin of FIG. 1.

It should be understood, of course, that the foregoing relates to exemplary embodiments of the invention and that modifications may be made without departing from the spirit and scope of the invention as set forth in the following claims.

What is claimed is:

1. A magnetic levitation spool assembly for a tip-up device, the assembly comprising:
a shaft extending between a spool end and a trip mechanism end;
a board engager disposed along the shaft between the spool end and the trip mechanism end;
a first set of one or more magnetized objects between the spool end and the board engager; and
a second set of one or more magnetized objects between the trip mechanism end and the board engager, wherein the first and second sets of one or more magnetized objects magnetically repel each other to produce a gap between each set of one or more magnetized objects and the board engager.

2. The assembly of claim 1, further comprising a spool connected to the spool end.

3. The assembly of claim 1, further comprising a trip mechanism connected to the trip mechanism end.

4. The assembly of claim 1, further comprising a magnetizable tube receiving the shaft, wherein the magnetizable tube is disposed between the spool end and the trip mechanism end, and wherein the board engager is connected to magnetizable tube.

5. The assembly of claim 4, wherein the gap between the magnetizable tube and each set of one or more magnetized objects is magnetically urged by each set of one or more magnetized objects.

6. The assembly of claim 1, wherein each set of one or more magnetized objects comprising a pair of magnetized objects.

7. The assembly of claim 6, further comprising a magnet cap between each pair of magnetized objects.

8. The assembly of claim 1, wherein each magnetized object is slidably connected to the shaft.

9. A method of decreasing friction between a plurality of magnetizable components of a tip-up device, wherein the plurality of magnetizable components is connected along a shaft of a spool assembly of the tip-up device, the method comprising:
disposing at least two magnetized objects along the shaft, wherein each two adjacent magnetized objects of the at least two magnetized objects is separated by a magnetizable component of the plurality of magnetizable components, wherein the two adjacent magnetized objects magnetically repel said magnetizable component to produce a gap between said magnetizable component and each of the two adjacent magnetized objects.
